(19) United States
(12) Patent Application Publication
(10) Pub. No.: US 2009/0237574 A1
(43) Pub. Date: Sep. 24, 2009

(54) Album for display of digitally produced images

(76) Inventor: Alan Chun Chiu, Kowloon (HK)

Correspondence Address: WILLIAM W. HAEFLIGER, 201 S. LAKE AVE, SUITE 512, PASADENA, CA, 91101, US

(21) Appl. No.: 12/077,150

(22) Filed: Mar. 18, 2008

(51) Int. Cl. H04N 5/64

(52) U.S. Cl. 348/836; 348/E05.128

(57) ABSTRACT

An image viewing apparatus comprising in combination a receptacle having the configuration of a photograph album, the receptacle having a top cover panel, a rear panel, and simulated pages between the panels, the simulated pages defining a first cavity opening towards the first cover panel, an image display device received in the cavity, and having an image display screen openly facing the cover panel in closed position, the cover panel being openable away from the display screen to reveal the screen, and means for electrically activating the device to display a selected image when the cover panel is opened.

### BACKGROUND OF THE INVENTION

This invention relates generally to image display equipment, and more particularly to an album type apparatus for electrically energized image display means.

Digital frames, or picture frames have been devised in which a portable rectangular frame surrounds a display screen, in which images are produced, digitally. Such devices lack the unusually advantageous improvements in structure, functioning and enhanced ease of use results, as are now provided by the album equipment to be described, whereby there is need for such improvements.

### SUMMARY OF THE INVENTION

It is a major object of the invention to provide improved apparatus meeting the referred to need.

Basically, the improved image viewing apparatus, which may be operated to digitally produce a succession of images in an album, comprises:

a) a receptacle having the configuration of a photograph album, the receptacle having a top cover panel, a rear panel, and simulated pages between said panels, the simulated pages defining a first cavity opening towards the top cover panel,

b) an image display device received in the cavity, and having an image display screen openly facing the cover panel in its closed position,

c) the cover panel being openable away from the display screen to reveal the screen, and images,

d) and means for electrically activating said device to display a selected image when the cover panel is opened.

As will be described, the said means typically includes a switch having magnetic elements in a circuit which is activated in response to said cover opening.

Another object is to provide a second cavity in the simulated album pages, a dry cell or cells in the second cavity and electrically connected to supply power to a circuit which activates said device in response to said cover opening.

Yet another object is to provide an additional cavity in the simulated album pages, accessible to an album user, said means including a manually operable control or controls in said additional cavity. That additional cavity may be located to define a window at an exposed edge of the simulated pages, between the front and back panels of the album. Alternatively, the additional cavity may be sunk in said simulated pages to be exposed when the front cover is opened.

The controls at the additional cavity may include a port for plug-in of an electrical current supply line having plug-in connection to the album, at one of said controls, to supply charging current to the dry cell or cells. Accordingly, the album may be self powered for use at locations remote from electrical power outlets.

A further object is to provide a window at a surface or surfaces of said simulated pages, and in alignment with said display and cavity.

Further, the image display device may comprise a digital frame type device, which has a flat frame with a rectangular boundary, in registration with a border defined by the cavity in the simulated pages.

An added object is to provide for reception of the digital frame in the cavity defined by the simulated pages so that the surface of that display is flush with the top surface of the simulated pages, and to provide a window at one edge of a page simulated stack, and a manually operable control or controls in or at said window, and operatively connected with said circuitry.

These and other objects and advantages of the invention, as well as the details of an illustrative embodiment, will be more fully understood from the following specification and drawings, in which:

### DRAWING DESCRIPTION

FIG. 1 is a perspective top and edge view of the preferred image viewing album device of the invention;

FIG. 2 is a bottom plan view of the FIG. 1 device;

FIG. 3 is a schematic view showing controls and electrical connections; and

FIG. 4 is a section taken in elevation on lines 4-4 of FIG. 1.

### DETAILED DESCRIPTION

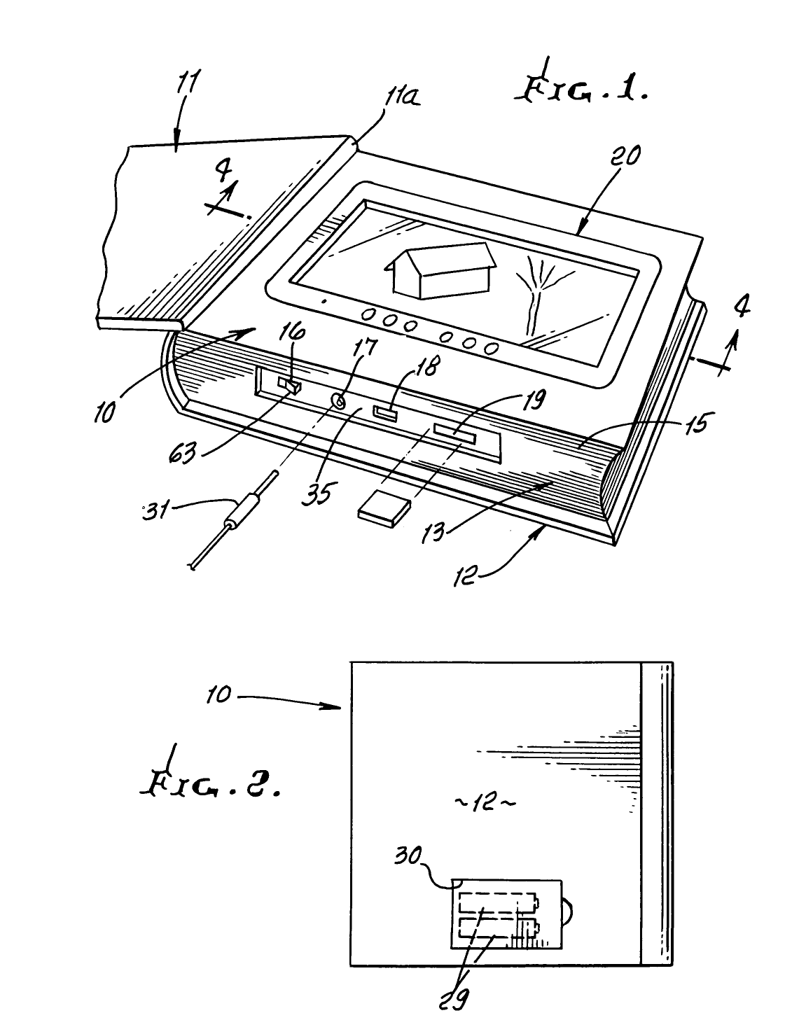

FIGS. 1 and 4 show the device as comprising a receptacle 10 having the configuration of a photograph album, the receptacle having a top cover panel, a rear panel, and simulated pages between said panels, the simulated stack of pages defining a first cavity opening towards the first cover panel. The front or top, cover panel is shown at 11, rear panel at 12, simulated pages at 13, and cavity at 14 exposed toward panel 11. Panel 11 folds at 11a toward open position seen in FIG. 1. The simulated pages of the album-like device define an edge or parallel edges at 15 between panels 11 and 12, as in a plastic block 13a. A second window 35 is formed in 13a, with elongation in the direction of simulated page edges, for reception of protected and accessible controls at 16-19 that are finger manipulable, selectively, by finger reception in the window recess.

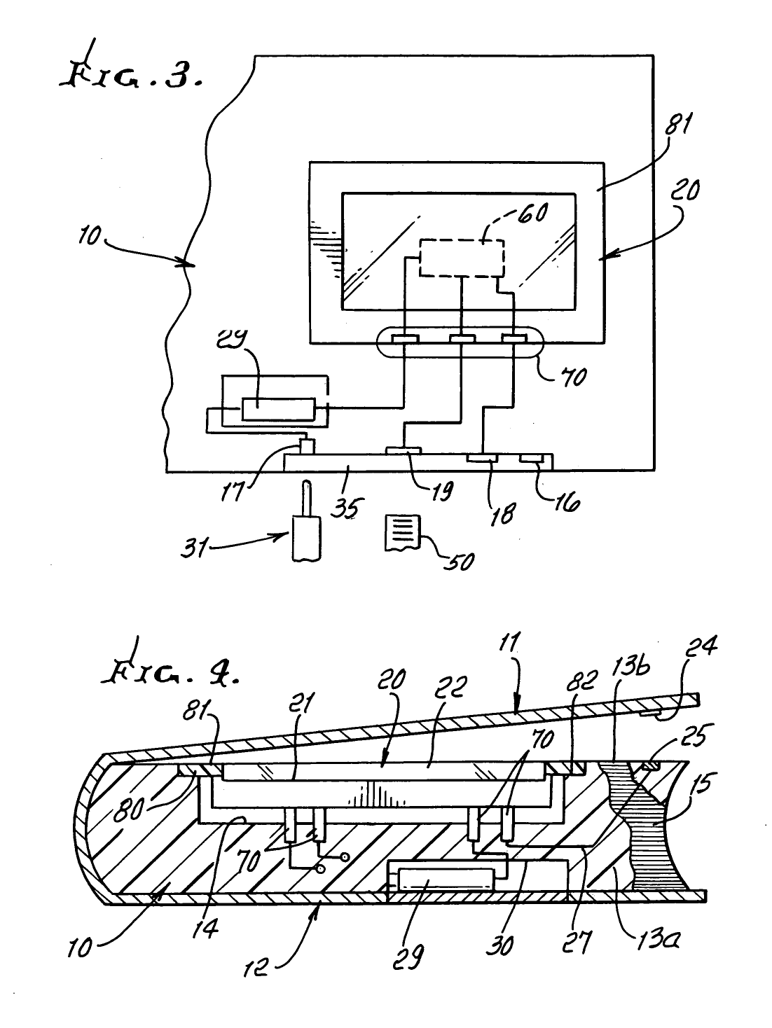

A visual image display device 20 is downwardly received in the cavity 14, as shown in FIG. 4, and has a screen at 21 directly beneath a transparent, see-through plate or window 22. The screen openly faces the album cover panel 11 to reveal images digitally presented on the screen when panel 11 is opened or unfolded, as in FIG. 1. Means is provided for electronically activating the device 20, turning it ON to display such images, as when the cover panel is opened. See for example the magnetically sensitive switch represented in FIG. 4 by magnetic element 24 carried by cover panel, and magnetically sensitive sensor 25 carried by the simulated pages. When 24 is moved upwardly away from sensor 25, a signal is transmitted on line 27 to device 20, turning it on, to be energized as by electrical batteries or dry cells 29 carried in another cavity 30 formed by the simulated stack of pages 13. Batteries 29 may be rechargeable, as via a DC or rectified AC current supply cord 31 having one end inserted in a port at 17 in or at window cavity 35, as seen in FIG. 3. A suitable transformer and rectifier may be provided in series with the cord conductor, so that household 60 volt AC current may be employed for re-charging.

Simulated page edges may be formed by molded-in striations in block 13a.

Port 19 is adapted to receive a program chip 50, for digitally programming circuitry 60 in device 20. See the schematic view in FIG. 3. An ON-OFF switch 63 may be provide at 16. Electrical connection lines may be connected as at 70, to circuitry 60, when device 20 is lowered into cavity 14.

As seen in FIG. 4, a shoulder 80 is provided by frame 81 to engage a recessed ledge 82 of block 13a, whereby the surface of plate 22 is flush with the top surface 13b of block 13a.

I claim:

1. An image viewing apparatus, comprising, in combination:
a) a receptacle having the configuration of a photograph album, the receptacle having a top cover panel, a rear panel, and simulated pages between said panels, the simulated pages defining a first cavity opening towards the first cover panel,
b) an image display device received in the cavity, and having an image display screen openly facing the cover panel in closed position,
c) the cover panel being openable away from the display screen to reveal the screen,
d) and means for electrically activating said device to display a selected image when the cover panel is opened.

2. The combination of claim 1 wherein said means includes a switch having magnetic elements in a circuit which is activated in response to said cover opening.

3. The combination of claim 1 wherein the simulated pages define a second cavity, a dry cell or cells in the second cavity and electrically connected to supply power to a circuit which activates said device in response to said cover opening.

4. The combination of claim 1 wherein the simulated pages define an additional cavity accessible to an album user, and sunk into a block forming said simulated pages, said means including a manually operable control or controls in said additional cavity.

5. The combination of claim 4 wherein said additional cavity is at an exposed edge of said simulated pages, between said front and back panels.

6. The combination of claim 4 wherein said additional cavity is sunk in said simulated pages to be exposed when the front cover is opened.

7. The combination of claim 3 wherein the simulated pages define an additional cavity accessible to an album user, said means including a manually operable control or controls in said additional cavity, and an electrical current supply line, having plug-in connection to the album, at one of said controls, to supply charging current to the dry cell or cells.

8. The combination of claim 4 including a window at a surface or surfaces of said simulated pages, and in alignment with said first cavity.

9. The combination of claim 1 wherein said device comprises a digital frame.

10. The combination of claim 9 wherein said digital frame has a rectangular frame bounding said display screen, the rectangular frame being in registration with a border defined by the first cavity.

11. The combination of claim 9 wherein said simulated pages define a shoulder bounding said cavity, said digital frame device having a rectangular frame engaging said shoulder which is recessed toward the back panel whereby a screen surface defined by said device and a surface defined by the rectangular frame are substantially flush with a surface defined by said simulated pages.

12. The combination of claim 11 wherein said deice includes control circuitry received in said first cavity.

13. The combination of claim 12 including a window at one edge of said simulated pages, and a manually operable control or controls in said window, and operatively connected with said circuitry.
